(19) United States
(12) Patent Application Publication
(10) Pub. No.: US 2016/0232191 A1
(43) Pub. Date: Aug. 11, 2016

(54) OVERLAYS TO MODIFY DATA OBJECTS OF SOURCE DATA

(71) Applicant: HEWLETT PACKARD ENTERPRISE DEVELOPMENT LP, Houston, TX (US)

(72) Inventors: Regan Adrian, Galway (IE); Mark Davis, Maynooth (IE); Raymond Glynn, Galway (IE)

(21) Appl. No.: 15/024,247

(22) PCT Filed: Sep. 30, 2013
(86) PCT No.: PCT/US2013/062639

§ 371 Date: Mar. 23, 2016

(51) Int. Cl. G06F 17/30; G06F 3/0484; H04N 1/387

(52) U.S. Cl. CPC G06F 17/30345; H04N 1/387; G06F 3/0484

(57) ABSTRACT

A system includes an overlay and transformer. The system is to identify, based on the overlay, a data object associated with source data. The overlay is applied to modify the data object. The data object is to be provided as resulting data to be interacted with as though it were the source data as modified by the overlay.

### BACKGROUND

An application environment may involve data available from multiple external data sources. Consumers of the data may face difficulties in addressing issues with data sources due to organizational or technical barriers isolating the data consumers from the data providers. Using traditional data correction approaches at a data source may result in incompatibilities among other applications that may depend on that data source. Furthermore, data correction may be costly and delayed because the data source is outside the control of the data consumer.

### BRIEF DESCRIPTION OF THE DRAWINGS/FIGURES

FIG. 1 is a block diagram of a computing system including a transformer and an overlay according to an example.

FIG. 2 is a block diagram of a computing system including a transformer and an overlay according to an example.

FIG. 3 is a block diagram of a computing system including an overlay engine according to an example.

FIG. 4 is a block diagram of a computing system including an overlay engine according to an example.

FIG. 5 is a block diagram of a computing system including an overlay engine according to an example.

FIG. 6 is a block diagram of a system including a transformer and an overlay according to an example.

FIG. 7 is a block diagram of an overlay interface according to an example.

FIG. 8 is a flow chart based on applying an overlay according to an example.

FIG. 9 is a flow chart based on applying an overlay according to an example.

### DETAILED DESCRIPTION

Examples provided herein are based on overlays, to enable a reduction in the overhead associated with enabling modifications to consumed data (e.g., from source data). An overlay may create a view of information from source data, without a need to change the source data at the data source itself. Thus, consumers of data services may tailor the data to their needs as necessary, independently and without affecting the source data or other consumers and their view of the source data (e.g., in environments such as a service-oriented architecture (SOA) where data is available as a service). Accordingly, examples are well-suited to data handling environments associated with a higher level of scrutiny placed on the data. Example systems are resilient to inconsistent or ‘dirty’ data provided by external services, e.g., errors within the external data whereby those in control of the data are unaware or unable to take corrective action in view of the errors within a timeframe desired by the data consumer. Overlays may be used to ‘step in’ as an authoritative reference source, in a targeted fashion, to minimize risk and disruption while reducing support and development costs. Benefits are achievable immediately, even when fixes to the original source data are deferred.

Thus, examples include enabling a data service consumer/client (e.g., an application) to: resolve errors in externally sourced data independently of those in control of the external data service, exclude unwanted data provided by an external data service on a per-case basis, augment data (from external data services) with additional data to be used by the consuming application, apply time-limits to augmentations and data adaptations etc., ensure business continuity by allowing data service consumers to respond more quickly to business needs compared to attempted collaboration with data service provider teams, and allow use of services that provide a high percentage of desired/required information while adapting portion(s) that may otherwise be unsuitable.

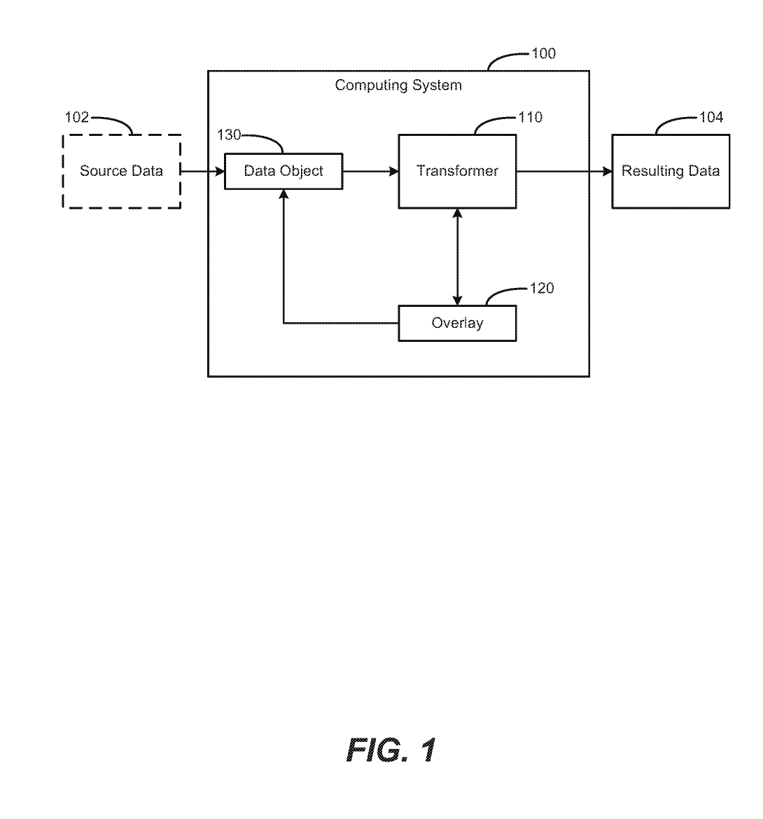

FIG. 1 is a block diagram of a computing system 100 including a transformer 110 and an overlay 120 according to an example. The computing system 100 is to obtain data object 130 from source data 102, based on overlay 120. The transformer 110 is to apply the overlay 120 to the data object 130 to obtain resulting data 104.

The overlay 120 may be temporary, user defined, and/or targeted. It may modify (e.g., augment and/or correct) source data 102 (e.g., externally maintained content). Overlay 120 may be targeted in the sense that it may be applied to even individual streams of content originating from a specific data provisioning source, and also to individual elements within those streams. Overlay 120 may be temporary in the sense that it may include modifications to be interacted with in lieu of definitive corrective action applied directly at the source data 102 by the authoritative data source provider. Overlay 120 may be user defined in the sense that business representatives (e.g., consumers of the source data 102) may own and interact with features of the overlay modifications (e.g., via a user interface (UI) and persistence layer) to define, test and maintain one or more overlays 120.

The overlay-based approach illustrated by example computing system 100 provides several advantages over direct cleansing of the source data 102. Overlays 120 are abstracted from the source data 102, so that corrections can be quickly applied to the data without impacting other clients of the data service. Overlays 120 can be applied consistently to all reference data sources, so a business lead can manage all data corrections in the same manner (e.g., via example computing system 100), without needing any costly interactions with external teams responsible for the source data 102. Computing system 100 can provide a centralized repository of data issues (e.g., a store of overlays 120) that can be managed by reference data teams. Thus, maintenance of the overlays 120 may be performed by those who are closest to the business needs and in control over how information from source data 102 may be augmented to provide resulting data 104.

The overlay process associated with computing system 100 may be provided as a service itself (e.g., as a shared business service), such as software on demand, software as a service, etc. Thus, although FIG. 1 illustrates computing system 100 as a discrete block, examples are not limited to deployments based on a client. Examples include providing overlay 120 and associated benefits as a service that may be called remotely. In an example, the overlay 120 may be called as a service, and may use a generic approach to apply an overlay 120, which has no references to any particular source data structure. The apply method may be a completely decoupled construct that may be applied to any similar situation and potentially any data structure. System 100 may provide an overlay service itself as a Shared Business Service, to provide overlay services even more easily in a service-oriented landscape.

In addition to being capable of being called as a service, the overlay 120 may be applied, e.g., through an interceptor using aspect orientated programming (AOP). Thus, a consumer (e.g., user, developer, etc.) of source data 102 may use overlaid data (e.g., resulting data 104) without a need to incorporate any code changes. For example, aspect orientated programming enables an interceptor, or super structure, outside of the user's code, based on identifying points in the code where external code may be injected. Thus, a user can invoke the overlay 120 based on straightforward calls such as ‘get source data’ and ‘update webpage.’ A developer may externally configure software applications so that an interceptor can identify the point where it updates, to inject code that is the overlay system. When the code is running, an overlay-based system may intercept a method call, using pattern matching etc., and provide resulting data 104 already modified by the overlay 120.

The transformer 110 is to apply the overlay 120. Transformer 110 (and other example components) may be provided as a module of code (e.g., java class in this case). Transformer 110 may be generic, enabling transformation rules to be specified externally to the transformer engine, or other implementation variations.

Thus, examples provided herein enable the use of overlays 120 to temporarily ‘step in’ as an authoritative reference source in a targeted fashion, minimizing risk/disruption to services, and providing a reduction in associated support and development costs. The overlay approach is more useful than traditional data cleansing techniques. Overlays 120 enable features including a data-agnostic service for matching data from a given source data 102 external service, the ability to augment or modify data 102 based on consumer-specified rules, the ability to set temporal limits to the augmentation rules, the ability to layer augmentations according to prioritization, the ability to match based on various rules (regular expressions, exact matches, etc.), the ability to work within a subset or stream of the source data 102, and the ability to avoid a need for additional persistence. The examples are flexible and may be implemented as various services, and may be implemented to include, e.g., a web UI for creating and interacting with the overlays 120 (or other components/features).

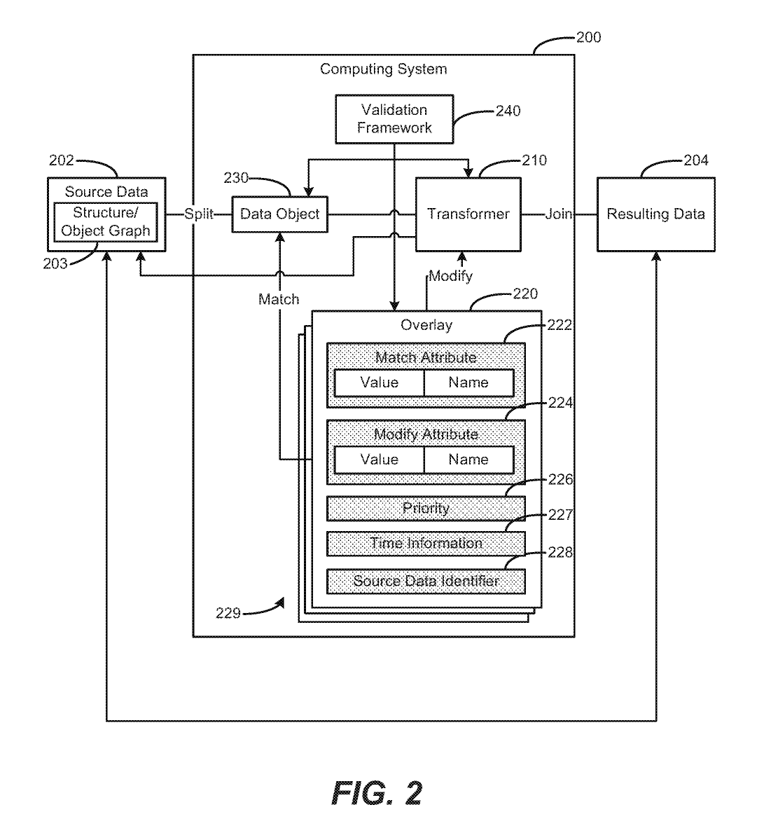

FIG. 2 is a block diagram of a computing system 200 including a transformer 210 and an overlay 220 according to an example. The computing system 200 is to obtain data object 230 from source data 202, based on overlay 220. The transformer 210 is delegated by system 200 (or other engine, e.g., overlay engine 500) to abstract the source data 202 and obtain the data object 230, so that the overlay 220 may be applied to the data object 230 to obtain resulting data 204. The transformer 210 may perform a split operation to separate the structure 203 from the source data 202 to obtain the data object 230. The overlay 220 may include a match attribute 222, modify attribute 224, priority 226, time information 227, and source data identifier 228. The computing system 220 may include an overlay repository 229 to store a plurality of overlays 220, and a validation framework 240 to check for valid operational states.

System 200 (or other engine, e.g., overlay engine 500) may delegate the transformer 210 to perform the abstraction of the source data 202 into data object(s) 230, e.g., via a split operation. System 200 also may delegate transformer 210 to re-integrate the data object(s) 230 (as modified by the overlay 220) back into resulting data 204, e.g., via a join operation. The system 200 may select what transformer(s) 210 and/or overlay(s) 220 to use on the data, and the selection may be based on various features such as an identity of the source data 202. The system 200 also may delegate tasks to the validation framework 240, such as performing an ‘apply’ method to apply an overlay 220, and validation of the overlays 220 and their interactions. Thus, the system 220 may coordinate the various components of FIG. 2, tying together all the features to obtain the desired resulting data 204.

The overlay 220 may interact with data based on a premise that the state of any data object 230 may be reduced to a non-structured format, such as a format based on key/value pairings (or other attributes). Thus, the overlay 220 may be viewed as a form of data polymorphism, in that the overlay 220 may be formed to extend or modify existing instances of a data object 230. Internally, the overlay 220 may contain a set of attribute objects, such as match attribute 222, modify attribute 224, etc. The set may represent the name and value of match attributes 222 that are to be matched in the source data 202. The overlay 220 may specify a type of match to be sought, such as an exact match and/or a match based on an expression. The overlay 220 also includes modify attribute 224, that contains a list of key/value attributes (e.g., value and name) that are to be extended/altered if the match attribute 222 is fulfilled.

The overlay 220 may include priority 226, which may be used (e.g., by system 200) to identify an order in which the overlay 220 is to be applied in relation to other overlays 220 (that may have their own priority 226). The priority 226 may be expressed in a number of ways, and is not limited to specifics like expressions such as hi/med/low or numerical expressions. The overlay 220 may include time information 227, which may include a time and/or range of time (e.g., start/finish) associated with when the overlay 220 should be applied. The overlay 220 may include a source data identifier 228 to identify the source data 202 that is/are to be targeted (e.g., among various potential source data 202 that are available, one or more sources may be targeted by one or more overlay(s) 220). Although single attributes are shown in FIG. 2, examples may include any number of attributes or other features in addition to those specifically illustrated.

The overlay 220 may serve as a vehicle to convey an intent to find and modify (e.g., override and/or augment) data from an external source. The attributes may be matched and/or modified based on exact and/or pattern-based (expression) matching, such as fuzzy matching of expressions/strings. Overlays 220 may perform matching based on specific prescriptive attributes, and also may match based on natural language creation/rules/syntax, which may be used to perform/specify overlay 220.

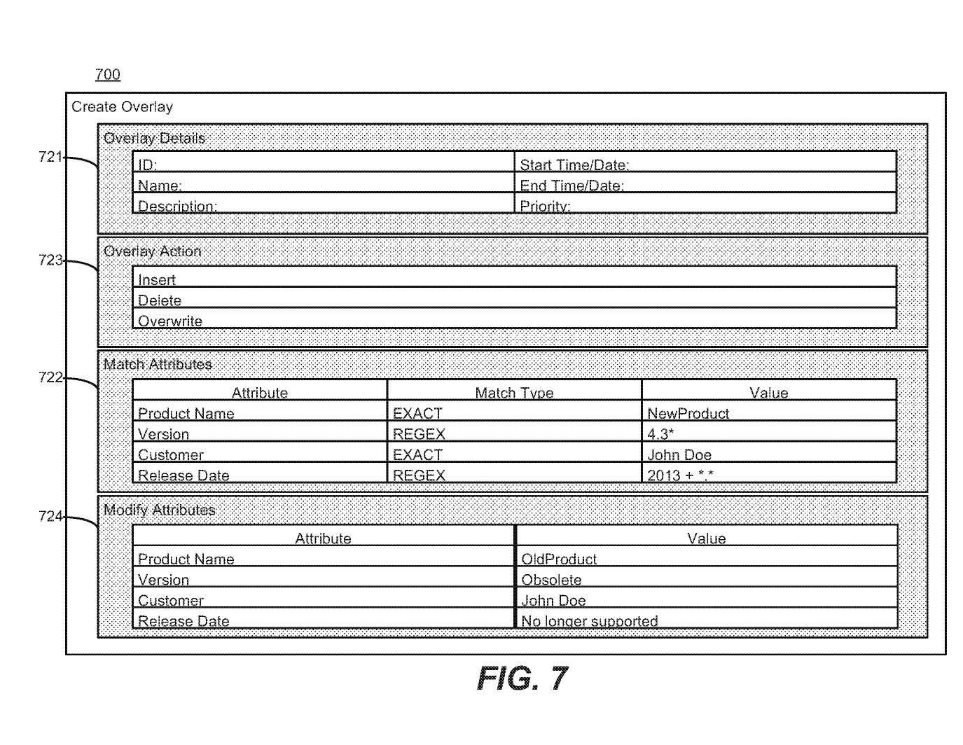

The overlay 220 may enable user interaction based on an overlay interface (e.g., see FIG. 7). Interaction may include limits on what parameters may be accepted for overlay attributes. In an example, a limit may be set on what values are within acceptable parameters for an entirety of a domain associated with the overlay 220. Overlays 220 may be built in view of specific challenges currently being faced for a given application/system. Overlays 220 also may be built to have their own unique user interface (e.g., on a per-overlay basis), including the use of multiple user interfaces across multiple domains. Similarly, other components of computing system 200 may enjoy customization of user interfaces for interacting with such components (e.g., transformer 210 etc.). User interfaces may be a function of the system 200, but are not prescriptive/limiting in that any forms may be created in the UI to interact with data or other components that may be relevant.

The source data identifier 228 of the overlay 220 may be specified using a user interface, to specify how to identify what source data 202 is to be targeted by the overlay 220. Thus, in an example, the source data identifier 228 may be used to lock its associated overlay 220 onto a data stream or other source of data that originates from a particular source data 202. Such behavior/attributes are selectable, e.g., in the UI/system application, to target the overlay 220 at a particular stream of information, even within a source data 202. This source data identifier 228 attribute may be extended to target whatever data stream is desired, including targeting multiple data streams at the same time and/or by the same overlay 220.

The priority 226 enables the use of multiple overlays 220, which may be applied iteratively and/or recursively. The overlays 220 may be applied in multiples (e.g., pooled), and the priority 226 attribute enables one overlay 220 to override another overlay 220 (e.g., of a lower priority 226). Thus, the system 200 enables overlays 220 to be interacted with as though they were a rules engine or the like, to be processed and/or applied to the source data 202 and data object 230. For example, one overlay 220 may be used to match data of a desired type, and another overlay 220 may be used to match slightly different/similar data. A third overlay 220 may be used to receive the results of the first two overlays 220 and perform yet another modification, iterating on top of the prior overlays. An overlay 220 may operate on the whole data set, and may operate on a subset (e.g., according to another overlay), and these interactions may be affected by the priority 226.

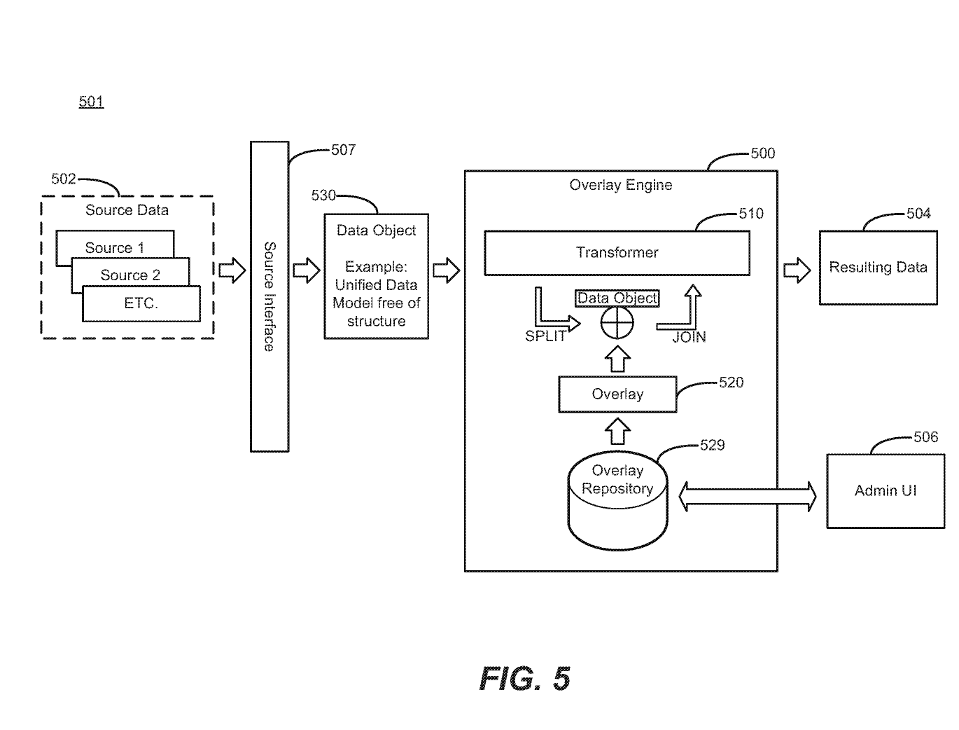

The priority 226 may be stored as shown, i.e., as a property of the overlay 220 itself, that may be administered in an Admin UI (see, e.g., FIG. 5, Admin UI 506). In alternate examples, the priority 226 may be managed outside the overlay 220, e.g., as an alternative to, or in addition to, the priority 226 stored in the overlay 220 itself, System 200 (e.g., an overlay engine 500) may include intelligence to assess one or more overlays 220, and determine a priority 226 to be associated with each of those overlays 220, based on what the overlays 220 are trying to match and/or modify. System 200 may address potential issues, and solve problems that would have arisen whereby one overlay 220 alters information that another overlay 220 is looking for, so that prioritization/intelligence between such overlays 220 may prevent such problems. A system 200 may detect that a lower priority overlay 220 would affect the properties of a higher priority overlay 220, and counterbalance such issues to prevent unintended modifications due to out-of-order application of modifications associated with overlays 220.

Additionally, System 200, or whatever engine is to apply the overlay 220, can detect certain issues with the overlays 220 themselves, independent of and/or in addition to issues that may arise due to priority. For example, system 200 may determine that applying overlay 220 would provide results that exceed an acceptable threshold number of results, or otherwise provide results that are not narrow enough to provide meaningful resulting data 204. System 200 also may apply a non-priority based control over overlays 220 that are of equal priority 226, where further control may be desired to avoid undesirable interactions.

Transformer 210 is to apply the overlay 220, and may be a generically defined interface and/or a type of strategy pattern. The transformer 210 may be used to decouple (e.g., split) a source data structure 203 from the process of applying overlays 220. Thus, source data 202 that may include a structure 203 such as an object graph may be flattened by the transformer 210 into a non-structured form to represent data object 230. Thus, the overlay 220 is freed from the constraints of needing to address various types of structure 203 in the source data 202, because such features may be handled by the transformer 210. The semantics for implementation-defined object graph deconstruction, and corresponding re-integration of altered content back into that object graph (e.g., join), therefore may be manageable separately from the overlay 220, at the transformer 210.

The transformer 210 may perform a split operation, which enables an ability for the implementer to nominate what elements of the original source data 202 should be forwarded to the application of an overlay 220 (e.g., applying the overlay 220 using a match/extend cycle etc.). The transformer 210 may perform a join operation to provide a facility to allow the implementer to decide how to reintegrate the modifications/changes, forming the resulting data 204 to include the original object graph/structure 203 as the source data 202. In an alternate example, the transformer 210 may reintegrate the resulting data 204 with a different structure 203 than that of the source data 202, or no structure at all.

The system 200 may match, extend, and/or augment a data object 230, based on application of an overlay 220, which will attempt to match based on the match attribute 222, and alter, extend, and/or augment based on the modify attribute 224. The transformer 210 facilitates universal applicability of the overlay 220, by deconstructing the object graph 203 of the source data 202 to provide resultant flattened data, which may include data object 230 to be searched for, by the overlay engine, according to match attribute(s) 222. Application of the overlay 220 may extend, add, or otherwise modify whatever attributes of the data object 230 according to what the overlay 220 is designed to do based on its attributes. The transformer 210 then may perform a join operation, where that flattened data object 230 may be reintegrated back into a desired model/structure, e.g., having a structure of the source data 202. Thus, the transformer 210 may genericize the source data 202 regardless of its original structure 203, to provide a generic model that may be modified by an overlay 220, enabling data augmentation/data polymorphism.

The transformer 210 may be implemented as a generic interface type, enabling flexibility and type safety in specifying the returned result of calling the join operation/method. As an alternative, an implementation may use java ‘Object’ classes, which may allow for flexibility of design but with reduced type safety. The transformer 210 thus enables interaction with disparate source data ranging from web services, files, and databases, to more fuzzy data such as emails and free text, based on customization to suit a given structure 203.

The transformer 210 enables decoupling of the overlay techniques from the data deconstruction techniques, and enables customization of the transformer 210 to address a suitable data source. For example, a transformer 210 may be customized to operate on a generic Extensible Markup Language (XML) source data 202, to deconstruct and/or reconstruct XML. A system 200 (e.g., an engine) may call the transformer 210 to perform the split operation, apply the overlay(s) 220, and call the transformer 210 to perform the join operation. Thus, the format of source data 202 may be provided so that the overlays 220 may understand and easily match/join against it, based on the transformer 210 being customized to various implementations of the source data 202. This may enable the overlays 220 to be generic across all services, and the overlays 220 may be provided pre-made (e.g., via repository 229) for users to plug the overlay repository 229 into the system/engine 220. The overlay repository 229 may be added to over time, enabling a user/data consumer to build-up the number of stored overlays 220 for usage on various source data 202. The transformer 210 may be created or customized by an end user (e.g., a developer team that is responsible for the code that consumes/deconstructs the source data 202 from a data service provide), who is in a good position for familiarity with that source data 202 and its structure 203.

The resulting data 204 may be reconstructed based on the join operation, but may be provided based on various options. In an example, the transformer 210 may reconstruct resulting data 204 that is a subset of the source data 202, including what has been changed relative to the source data 202 as a separate debug stream or the like. The resulting data 204 may be reintegrated back into an exact same or similar construct as the source data 202, including the same data structure 203, but with the changes as modified by the overlay 220. The source transformer 210 may be customized to manage such aspects of producing the resulting data 204, based on the decoupling of the overlay engine from the source data structure 203.

System 200 may include a closed loop feedback mechanism to enable the resulting data 204 to be fed back to, or otherwise used to update, the source data 202. System 200 may feed back the elements that have been changed by an overlay, or send a fully updated structured dataset replacement. In an example, a source data service provider may provide an agreement to receive ‘cleaned’ information that has been modified by overlays 220, enabling the source provider to apply the changes at the source data 202. However, such systems may address a need of other services that may be consuming the source data 202, to avoid changing an attribute whose value another consumer of that service was depending on, to avoid breaking the other service.

The use of overlays 220 can enable changes to data, e.g., as resulting data 204, to be used for different purposes without disruption between services that all may depend on that source data 202. Such benefits may be particularly useful in a service oriented architecture context, allowing consumption of data source services without breaking other services. Even if the source data 202 is eventually updated, the overlays 220 may intelligently recognize and/or accommodate such changes, e.g., by harmlessly non-matching situations and/or by deactivating themselves, etc. The overlay 220 may be time limited (based on time information 227), and can be inactivated in other ways (e.g., manually through an overlay UI). The time information 227 may be used to time-box itself, providing a window of time in which the overlay 220 is to remain active. Thus, overlays 220 enable a data consumer to detect that there is a problem with the source data 202 being consumed, create an overlay 220, time-box the overlay (e.g., remain active for the next three weeks), and apply the overlay to address the problem. Meanwhile, the data consumer may contact the provider of the source data 202 and request that the problem be fixed through whatever mechanism the provider may use. Upon expiration of the time box, the overlay will no longer match. Further, upon resolution of the problem, the match attributes 222 will no longer match. Accordingly, application of overlays 220 can provide efficient solutions when needed, and remain harmless when no longer needed/applicable.

System 200 enables more than one transformer 210 to operate at a given time. In an example, a system may implement a debug output or other type of feedback loop to pick up changes. A first transformer 210 may transform the source data 202 for the purposes of fully reconstructing it, and a second transformer 210 repeat the transformation, but including the changes. The resulting data 204, or other transformer output, may be directed back into the source data 202 itself. Accordingly, various examples may make use of multiple transformers operating in various capacities, and examples provided herein are not intended to be limited to the diagrams as specifically illustrated.

Validation framework 240 may provide support to operation of the system 200, to mitigate potential issues of overlays 220 interacting with data. For example, overlays 220 may target the same data or where the target scope of an overlay is too wide to be useful (and may potentially be dangerous to data integrity). The validation framework 240 may prevent a low priority overlay 220 from ‘usurping’ a higher priority overlay 220, by preventing the low priority overlay 220 from altering the attributes that are needed to provide a match in the higher priority overlay 220. The validation framework 240 may prevent excessively wide-scope overlays 220 based on, e.g., determining that the match attribute 222 of the overlay 220 is attempting to match on an attribute value (e.g., via a REGEX) that potentially would result in excessive reference data being deleted/overridden.

The validation framework 240 may check for issues as part of an overlay interface, where a user may specify characteristics of the overlay 220. The overlay 220 thus may be validated upon creation, e.g., when the overlay 220 is being saved to the overlay repository 229. The validation framework 240 may check in other locations, such as upon the detection of threatening and/or erroneous conditions that should not be allowed. The validation framework 240 may monitor system 200 for undesirable behavior, e.g., as part of the actual application process itself. For example, the validation framework 240 may find that an overlay 220 is repeatedly violating certain conditions, and the validation framework 240 may disable the overlay 220. Validation checking may be performed initially, on an ongoing/monitoring basis, and/or upon completion of application of the overlay 220, and/or other times.

The system 200 and/or validation framework 240 may identify and/or characterize undesirable situations based on error conditions and warning conditions, for example. A validation framework 240 may identify a warning condition in the following example. A wide-scope overlay 220 may be presented, to match a single attribute using a regular expression (REGEX) such as *.* or similar, which, if run, would match everything. The validation framework 240 may check this overlay 220 and identify that application of this overlay 220 will potentially be too wide in scope for what was intended, issue the warning condition. The validation framework 240 in another example may identify an error condition by quantifying that an overlay 220 is going to actually interfere with a higher priority overlay 220, by detecting the interference (e.g., behaving in conflict with the overlay priority 226), and issue the error condition. The validation framework 240 may take action (such as suspending an overlay) based on the situation, in addition to identifying the conditions.

System 200 provides a benefit in that a subset of the source data 202 may be analyzed to identify the data object 230, such that it is not needed to analyze the entirety of the source data 202. In contrast to other attempts at data scrubbing (e.g., using XML format to serialize the source data 202), the entire source data 202 need not be consumed and analyzed. Examples provided herein may be applied to a data stream (e.g., to a subset of the source data 202). Thus, by working on a subset of the source data 202, results are available as soon as they are found, without having to wait for processing of the entire source data 202. In an example, the system 200 may provide an overlay 220 to check frame-capture images from a video stream source data 202 to match an image, such that the system 200 may process the video stream up until the point the overlay 220 satisfies a match condition and pulls the needed frame image.

There is no prerequisite for the actual structure of the source data 202. The source transformation enables a development team to provide a probable transformation process to reduce source data 202 into a format to which an overlay 220 may be applied, enabling a form of decomposition of the source data 202. This structure-centric application is customizable by whomever the business or domain experts happen to be, i.e., giving the power to those most familiar with the data to be analyzed. Example systems provide freedom to design custom UIs as well as transformation services that can accommodate whatever type of source data 202 may be presented, for generic application as desired.

Examples provided herein may be implemented in hardware, software, or a combination of both. Example systems can include a processor and memory resources for executing instructions stored in a tangible non-transitory medium (e.g., volatile memory, non-volatile memory, and/or computer readable media). Non-transitory computer-readable medium can be tangible and have computer-readable instructions stored thereon that are executable by a processor to implement examples according to the present disclosure.

An example system (e.g., a computing device) can include and/or receive a tangible non-transitory computer-readable medium storing a set of computer-readable instructions (e.g., software). As used herein, the processor can include one or a plurality of processors such as in a parallel processing system. The memory can include memory addressable by the processor for execution of computer readable instructions. The computer readable medium can include volatile and/or non-volatile memory such as a random access memory (“RAM”), magnetic memory such as a hard disk, floppy disk, and/or tape memory, a solid state drive (“SSD”), flash memory, phase change memory, and so on.

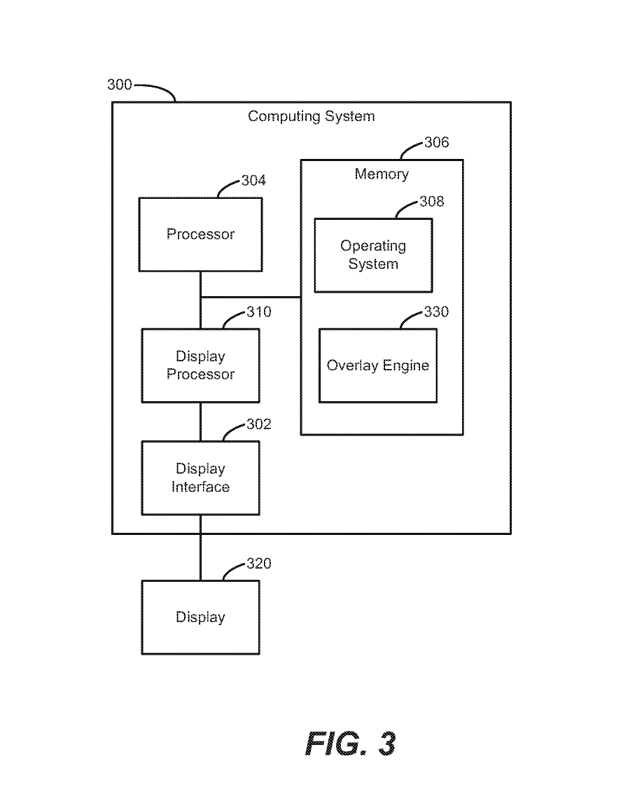

FIG. 3 is a block diagram of a computing system 300 including an overlay engine 330 according to an example. The computing system 300 also may include a processor 304 (e.g., a CPU), memory 306, display processor 310, and display interface 302. The memory 306 of computing system 300 may be associated with operating system 308, as well as the overlay engine 330. The display processor 310 may interface with the display 320 based on display interface 302. The display 320 may be a physical hardware display, and also may include virtualized displays.

In an example, the overlay engine 330 may direct the processor 304 to operate as an overlay engine. Thus, the processor 304 may include hardware/circuitry (such as an application specific integrated circuit (ASIC)) to provide the benefits described herein.

Processor 304 (as well as overlay engine 330) may be any combination of hardware and software that executes or interprets instructions, data transactions, codes, or signals. For example, processor 310 and/or overlay engine 330 may be implemented as a microprocessor, an Application-Specific Integrated Circuit (ASIC), a distributed processor such as a cluster or network of processors or computing device, and/or a virtual machine etc.

Overlay engine 330 may be a software module residing in system memory 306 and in communication with processor 304. Computing system 300 may communicate via the display interface 302 (e.g., to provide displayed signals representing data or information) with at least one display 320. Display 320 is to include a number of pixels that may be organized in columns, rows, and so on, to be addressed by the display processor 310. Display processor 310 may include hardware (e.g., pins, connectors, or integrated circuits) and software (e.g., drivers or communications stacks). For example, display processor 310 can communicate via traces to pins forming the display interface 302 such as a video graphics array (VGA), digital visual interface (DVI), high-definition multimedia interface (HDMI), DisplayPort, or other graphical interface.

Memory 306 is a processor-readable medium that stores instructions, codes, data, or other information. For example, memory 306 can be a volatile random access memory (RAM), a persistent or non-transitory data store such as a hard disk drive or a solid-state drive, or a combination thereof or other types of memories. Furthermore, memory 306 can be integrated with processor 304 and/or display processor 310, or separate therefrom, or external to computing system 300.

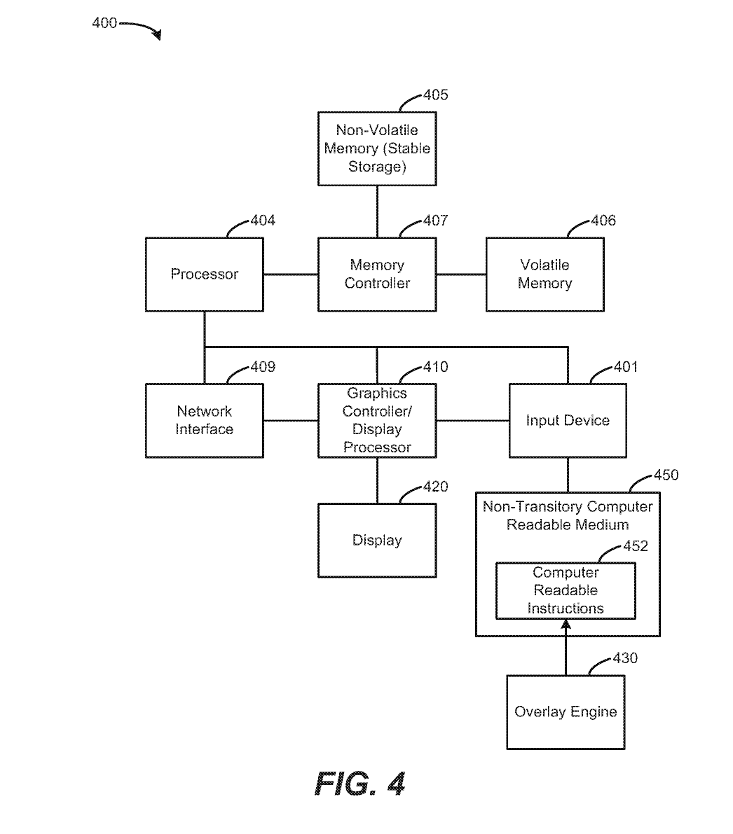

Operating system 308 and display processor driver 330 may be instructions or code that, when executed at processor 304 and/or display processor 310, cause processor 304 and/or display processor 310 to perform operations that implement features of operating system 308 and overlay engine 330. In other words, operating system 308 and overlay engine 330 may be hosted at or otherwise loaded onto computing device 300. More specifically, overlay engine 330 may include code or instructions that implement the features discussed above with reference to FIGS. 1 and 2, for example. Additionally, overlay engine 330 may include code or instructions that implement features discussed with reference to FIGS. 4-9.

In some implementations, overlay engine 330 (and/or other components as disclosed herein throughout) may be hosted or implemented at a computing device appliance. That is, the overlay engine 330 and/or other components may be implemented at a computing device 300 that is dedicated to hosting the overlay engine 330. For example, the overlay engine 330 can be hosted at a computing device with a minimal or “just-enough” operating system, and/or virtualized computing systems having virtualized displays. Furthermore, the overlay engine 330 may be a primary software application hosted at the appliance.

FIG. 4 is a block diagram of a computing system 400 including an overlay engine 430 according to an example, and may be implemented in hardware, software, or a combination of both. Computing system 400 may include a processor 404, display processor 410, and memory resources, such as, for example, the volatile memory 406 and/or the non-volatile memory 405, for executing instructions stored in a tangible non-transitory medium (e.g., volatile memory 406, non-volatile memory 405, and/or non-transitory computer readable medium 450). The non-transitory computer-readable medium 450 can have computer-readable instructions 452 stored thereon that are executed by the processor 404 and/or display processor 410 to implement overlay engine 430 according to the present examples.

A machine (e.g., computing system 400) may include and/or receive a tangible non-transitory computer-readable medium 450 storing a set of computer-readable instructions 452 (e.g., software) via an input device 401. As used herein, the processor 404 and/or the display processor 410 can include one or a plurality of processors such as in a parallel processing system. The memory 406 can include memory addressable by the processor 404 and/or display processor 410 for execution of computer readable instructions. The display processor 410 may include its own discrete display memory (e.g., graphics memory) that may be loaded with instructions. The computer readable medium 450 can include volatile and/or non-volatile memory such as a random access memory (RAM), magnetic memory such as a hard disk, floppy disk, and/or tape memory, a solid state drive (SSD), flash memory, phase change memory, and so on that may be readable by the input device 401. In some embodiments, the non-volatile memory 405 can be a local or remote database including a plurality of physical non-volatile memory devices. Non-volatile memory 405 may include: a Parallel AT Attachment (PATA) interface, a Serial AT Attachment (SATA) interface, a Small Computer Systems Interface (SCSI) interface, a network (e.g., Ethernet, Fiber Channel, InfiniBand, Internet Small Computer Systems Interface (iSCSI), Storage Area Network (SAN), or Network File System (NFS)) interface, a Universal Serial Bus (USB) interface, or other storage device interfaces. Display processor 410 can also include other forms of memory, including non-volatile random-access-memory (NVRAM), battery-backed random-access memory (RAM), phase change memory, and so on.

The processor 404 can control the overall operation of the computing system 400. The processor 404 can be connected to a memory controller 407, which can read and/or write data from and/or to volatile memory 406 (e.g., random access memory (RAM)). The processor 404 can be connected to a bus to provide communication between the processor 404, the network interface 409, display processor 410, and other portions of the computing system 400. The non-volatile memory 405 can provide persistent data storage for the computing system 400. Further, the network interface 409 may be used to communicate, e.g., to receive and/or provide source data and/or destination data (which may be received/provided via other techniques, such as memory or computer readable instructions).

A computing system 400 can include a computing device having control circuitry such as a processor, a state machine, ASIC, controller, and/or similar machine. As used herein, the indefinite articles “a” and/or “an” can indicate one or more than one of the named object. Thus, for example, “a processor” can include one or more than one processor, such as in a multi-core processor, cluster, or parallel processing arrangement.

FIG. 5 is a block diagram of a computing system 501 including an overlay engine 500 according to an example. Source data 502 may be interacted with via source interface 507, to identify source data 502 and/or provide data object 530. The overlay engine 500 may obtain the data object 530 and provide resulting data 504. The overlay engine 500 may include a transformer 510 and overlay 520 (e.g., from overlay repository 529). The overlay repository 529 may be interacted with based on admin user interface (UI) 506. The transformer may be applied by the overlay engine 500 to obtain the data object 530 de-coupled from structure, and the overlay engine 500 may apply overlay 520 to the abstracted data object 530 to provide the resulting data 504.

The overlay engine 500 may be rendered on any system, including a local computing system, virtual system, remote server, and so on. The overlay engine 500 is to interact with and use various source data 502, such as external/web services, expert reference data, and the like. The source interface 507 enables a customizable technique for choosing what source data 502 to target. Those source data 502 may be controlled by other owners or otherwise difficult to modify at the source, and the overlay engine 500 is a module to make the source data 502 more consumable and convenient for obtaining resulting data 504. For example, the overlay engine 500 may interact with a source data that can satisfy, e.g., 90% of a client's needs, but perhaps that source data 502 is too slow to implement changes, or not quite suitable in certain areas, or otherwise needing to be augmented, scrubbed, and/or enhanced in some way, before the client uses the source data 502. Overlay engine 500 enables such scenarios.

The overlay engine 500 can potentially include a number of implementations of transformers 510 ‘plugged in’ for use in addressing the various source data 502 (e.g., for each type of potentially ‘dirty’ source data). The overlay engine 500 may operate according to the following example:

1. Get transformer 510 corresponding to source data 502

2. Call a ‘split’ operation on the transformer 510, so that transformer 510 may extract a collection of data objects 530 from the source data 502. The data object 530 may be a construct to capture an element of data from the source data 502 that has been deemed fit for overlaying. The data object 530 may incorporate an identification schema, suitable to a format of the source data 502, such that the data object 530 may be ‘re-integrated’ back into a structure of the source data 502 if so desired,

3, Perform the overlay match/modify (e.g., alter/extend) on the collection of data object 530 (e.g., application of overlays 520)

4. Call a ‘join’ operation on the transformer 510, and return to the caller whatever type of object (e.g., resulting data 504) is returned from the join operation.

In an example, an interface for the transformer 510 may be programmed in java language as follows. In alternate examples, any suitable programming language may be used to express these concepts:

```
public interface SourceTransformer<T> {
  /**
  * This method is used to ‘INSERT’ a new object
  * as part of the process of applying overlays.
  *
  * <em>Note: Can return null if source is null</em>
  *
  * @return a new OverrideableObject or potentially null
  */
  OverrideableObject createlnsertableObject( );
  /**
  * Implementation specific ‘splitting’ of source
  * data into OverrideableObjects for use in the
  * application of an overlay
  *
  * @return
  */
  Collection<OverrideableObject> split( );
  /**
  * Implementation specific joining of the results of
  * overlay back into the source data.
  *
  * @param results a list of OverrideableObject that have been
  * created as part of the application of an overlay
  *
  *  @return A list of completed source objects with overlays
  */
  T join(Collection<OverrideableObject> results);
}
```

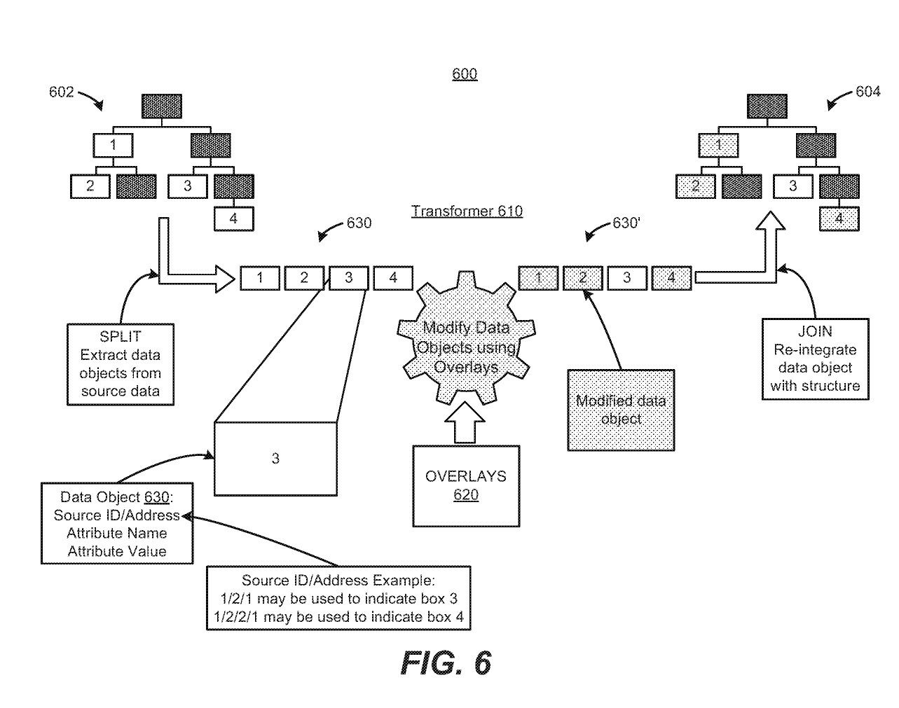

FIG. 6 is a block diagram of a system 600 including a transformer 610 and an overlay 620 according to an example, The source data 602 is shown having a structure, and the transformer 610 may perform a split operation to separate the data objects 630 from the structure to provide flat data. System/engine 600 may apply the transformer 610, and may apply the overlays 620 to achieve modified data objects 630′. The system 600 may apply the transformer 610 to perform a join operation to re-integrate the data objects 630 with structure, as shown by resulting data 604.

Source data 602 includes a structural relationship among its data values. In an example, the source data 602 may correspond to weather service data including nodes within that data for Country, Region, and so on. These relationships may be captured in the form of a graph, e.g., as a parent-child relationship, that may be repeated many times over. Because there is an overhead associated with traversing the graph/structure, the application of the overlay 620 may be affected if it needed to traverse the graph structure to perform modification. Accordingly, the source transformer 610 may deconstruct/flatten the source data 602, to remove the structure/form (i.e., graph) from the source data 602, by performing the split operation. The flattened data structure may be used for applying the overlays 620, without a need for the overlays 620 to deal with the structure. The transformer 610 may rebuild the graph structure, by maintaining knowledge of the initial structure addressed during the split operation. In an example, a tree data structure may be decomposed to a list to be modified and re-integrated back into a tree structure. Other types of structures, may be used, such as linked lists, arrays, and so on.

The data object 630 may include various attributes that may be used for matching the data object 630, modifying the data object 630, and for other benefits. In the example of FIG. 6, the attributes are shown to include a Source Id/Address, but may include a collection of any Key/Value pairs or other attributes. The Source Id/Address may be used to identify the structure of the data, and may correspond to 1/2/2/1 to denote box numbered ‘4’ in the tree structure of the source data 602. The collection of Key/Value pairs of the data objects 630 may be matched to an overlay 620, which can add or modify the collection.

The data object 630 is not limited to a single Key/Value pair, may include a plurality/collection of Key/Value pairs. This collection of key/value pairs may represents an identified subset of the source data 602 (the blocks in the tree diagram). The overlay 620 may be applied to the data object 630 by matching across the collection of key/value pairs contained within, and modify the matching data objects 630 according to the attributes in the overlays 620, to produce modified data objects 630′.

The transformer 610 may perform the join operation, to re-integrate the collection of data objects 630, 630′ back into resulting data 604. Example transformer 610 are not limited to a simple re-integration. An example may deal with only altered or unaltered content. In an example, as the source data 602 contains some sort of structure, the transformer 610 may flatten that structure, the overlays are applied to the flattened structure, and then the system 600 (overlay engine) asks the source transformer to reconstruct/unflatten the data objects 630, 630′, to incorporate the changes and reintegrate the changes back into the structured data.

Thus, the transformer 610 may convert structured information, to remove a dependency of the information on structure, for application of the overlays 620. By removing that dependency on structure, through the split operation as shown in the present example, the transformer may maintain the knowledge of how to reconstruct the structure and re-integrate those changes back in to the data. System 600 enables that structure-identifying knowledge to reside in a separate module/process, delegating the responsibility to the transformer 610 to enable specialization in dealing with disparate structures and associated structural complexity that may accompany the source data 602.

Thus, the source transformer 610 can reduce structure to something that is manageable, to a known flattened object of key-value pairs (attribute name and attribute value), to enable improved performance of the overlays 620 and their application to the flattened data.

FIG. 7 is a block diagram of an overlay interface 700 according to an example. An interface to create an overlay is shown. The interface 700 may include various features, including overlay details 721, overlay action 723, match attributes 722, and modify attributes 724.

The overlay details 721 may include various descriptive pieces of information, such as an identification, name, and description for the convenience of managing the overlay. Furthermore, the overlay details 721 may include information that is used when applying the overlay, such as the priority attribute and the timing attributes (for time-boxing or other uses).

The overlay actions 723 may include insert, delete, overwrite, and so on. The overlay may be associated with one of the overlay actions 723, selected to designate an action for the overlay to take when the match attributes 722 are satisfied, and the modify attributes 724 are applied. In an example, the overlay action 723 may be chosen to be “overwrite,” and the overlay may overwrite the matched attributes (as specified in the match attributes 722 section) with the new values specified in the modify attributes 724. The overlay action 723 may be set to one selection among the overlay actions 723 per overlay, such that multiple overlay actions 723 may be accomplished using multiple overlays. In an alternate example, a plurality of overlay actions 723 may be used in a single overlay to accomplish a plurality of actions in response to the match attributes being satisfied. Multiple overlays may be created, each performing its own action to data objects.

The overlay interface 700 may be used as a UI to accept overlay information that is fed into an analysis engine to address source information that is dirty at the source. A first report may be generated, e.g., as a result of incorrect data, and a second report may be generated showing the correct data as modified by the overlay(s). The overlay interface 700 may be accessible (e.g., via a local system onsite, via remote web services, etc.) by a business owner data consumer, so that generation of reports and managing the overlays may be accomplished by those data consumers having most familiarity with the data (in contrast to having a search firm prepare a search for the end user consumer of the data).

In an example scenario illustrating usage of the overlay interface 700, a support call is raised that there is an invalid revision present in a software release analysis report. An overlay investigation is started and identifies that for product number J8692A, the supported revision K.14.92 is incorrect. The source data provider (software team) is contacted and requested to remove that version from the source data records, at the source. Before that correction/update takes effect (e.g., while that change is being processed), overlay having an overlay action 723 of “delete” is created using the overlay interface 700. The delete overlay is to remove the offending version until such time as the data source provider has updated the source data. The source data provider has stated that the version will be removed from the source data by 2013 Jan. 31.

Thus, the overlay interface 700 may be used to insert fields and create the overlay to address the issues with the source data, so that the end user can work with updated information even before the source data provider has corrected the source data. In this case, an overlay action of exclude is to exclude the unwanted version information. The match attributes 722 that are identified as being incorrect are for Product Name: J8692A and Version: K.14.92. Such values would result in the overlay satisfying a match condition for the search parameters to override the undesired information.

The overlay details 721 may include a start and end time/date to ensure that the time-boxed valid period for the overlay extends to 2013 Jan. 31, corresponding to the date by which the source data provider has committed to updating their reference source data, such that the overlay ideally will not need to be active after that date. The overlay may go inactive at that time/date, but if the source data provider is unable to meet this deadline, the overlay can be extended or re-activated. Alternatively, if the data is corrected at the source, the overlay should no longer match, so no harm to the data would arise.

The overlay may be saved to an overlay repository, and appear in a list of available and/or active overlays that may be applied to given data. Once the overlay has been created, tested, and made active, an assessment may be run to determine if the overlay is functioning properly. The example overlay should cause the supported revisions section of the data to not contain a reference to version K.14.92, which should have been excluded. By running a report/assessment, the selected overlays that satisfy their match attributes 722 may modify the data to produce the desired results, without a need to modify the source data at the source. Accordingly, a consumer of the source data may continue operations using fully correct data, without having to worry whether the source data provider is up to date on all the requested fixes to the data.

In an alternate example, the overlay may include an overlay action 723 selected as “overwrite,” as follows. A support call is raised that there is an invalid uniform resource locator (URL) present in a release analysis report (i.e., indicating an issue with the source data used to generate the analysis report). An overlay investigation is started and identifies that for Product Number J8692A, Version K.14.92, the Hyperlink in the Reference Link is incorrect. The source data provider is contacted and requested to update the URL in the source data records. While that change is being processed, an overwrite overlay is created (including the overlay action 723 “overwrite”) to overwrite the offending URL, until such time as the source data provider has updated their records. The source data provider has stated that the Version will be removed by 2013 Jan. 31. Thus similar to the above example, the overlay may be applied to produce the desired resulting data, free of errors regardless of when the source data provider get around to updating their source data.

The overlay may include various fields, including the following. Id: internal key identifier of the overlay. This is populated when the overlay is saved. Name: a brief title describing a purpose of the overlay. Description: the overlay may include a detailed description, referring to why the overlay is being created and/or edited, and may reference the submitter of the support call and for how long the overlay is determined to be active. Source: the overlay may depend on a particular source data to be targeted for application of the overlay (e.g., to find a data object that will satisfy the match attributes 722). Priority: priority may indicate the execution time of the overlay during application, relative to other overlays. An overlay having a higher priority may be executed later (subsequent to earlier-executed overlays), possibly overwriting a lower priority overlay, based on a priority check on an overlay and comparing that to previously executed overlays. Priorities may include 1) lowest, 2) low, 3) default, 4) high, and 5) highest, although priority systems/rankings may be used. Note: Additional rules/checks may be used to settle a ‘tie,’ e.g., if two overlays having the same priority happen to match the same piece of data and attempt to override the same attribute(s). Time-box (valid period—from . . . to): overlays may include an activation period, which determines for how long an overlay is applied to a source data. The overlay may remain active while the data includes an issue. Once the issue with the data is fixed at source, the overlay may be de-activated. Reason for Overlay: a prescribed reason outlining why the overlay is to be created, e.g., due to invalid firmware.

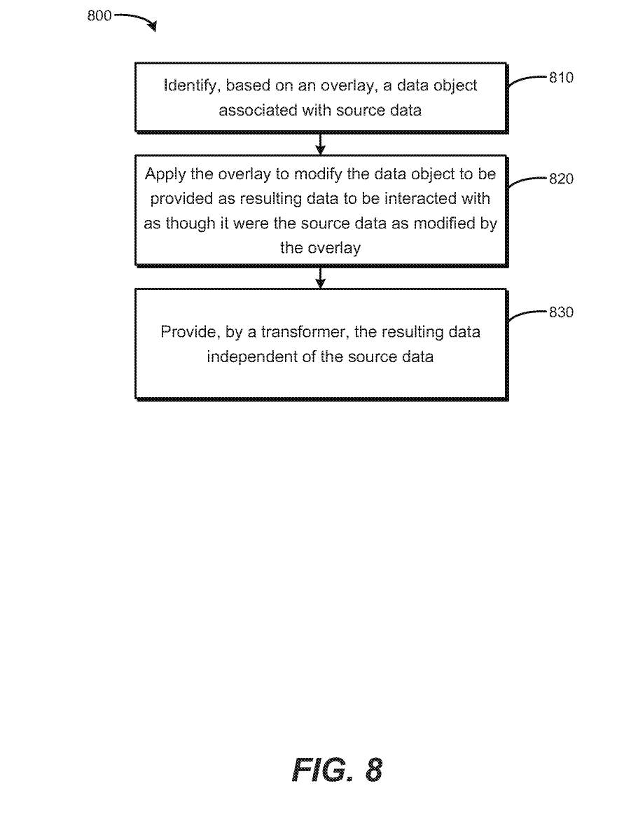

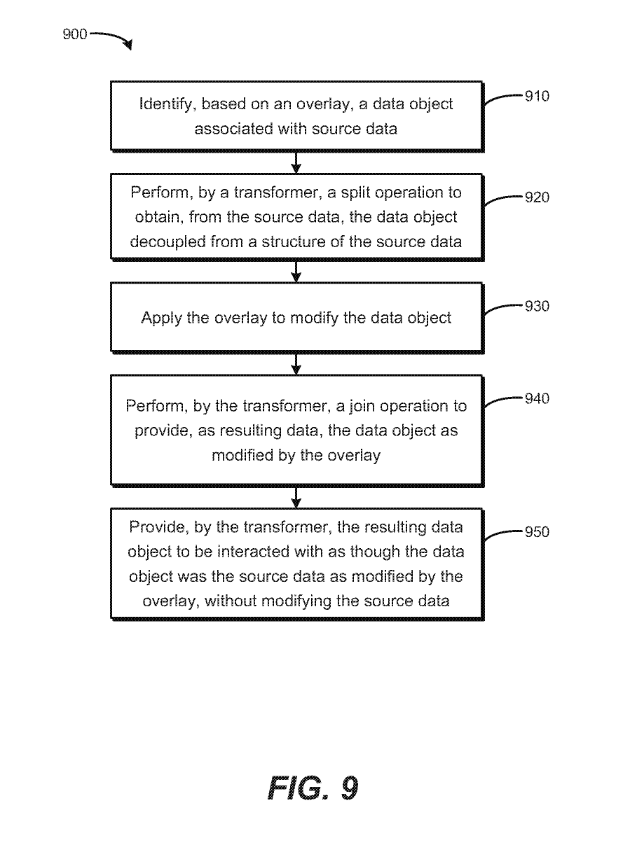

Referring to FIGS. 8 and 9, flow diagrams are illustrated in accordance with various examples of the present disclosure. The flow diagrams represent processes that may be utilized in conjunction with various systems and devices as discussed with reference to the preceding figures. While illustrated in a particular order, the disclosure is not intended to be so limited. Rather, it is expressly contemplated that various processes may occur in different orders and/or simultaneously with other processes than those illustrated.

FIG. 8 is a flow chart 800 based on applying an overlay according to an example. In block 810, a data object associated with source data is identified, based on an overlay. For example, the overlay may include various match attributes that are used to search at least a portion of the source data to satisfy the match attributes and thereby identify the data object to be modified. In block 820, the overlay is applied to modify the data object to be provided as resulting data to be interacted with as though it were the source data as modified by the overlay. For example, the transformer may perform a split operation to separate the data object from a structure of the source data, the overlay modification may be applied to the resulting flat data object, and the transformer may perform a join operation to re-integrate the modified data object with a desired structure (that may or may not be the same as the source data structure). In block 830, the resulting data is provided by the transformer independent of the source data. For example, the resulting data may be provided as a debug stream of changes, to be fed back to the source data provider so that the source data may be corrected. The resulting data also may be provided as a copy of the source data including its structure, but updated to include the modifications as indicated in the overlays.

FIG. 9 is a flow chart 900 based on applying an overlay according to an example. In block 910, a data object associated with source data is identified based on an overlay. For example, the overlay may include information to identify a source data to target, and search that source data for any data objects that satisfy the matching criteria of the overlay. In block 920, a split operation is performed by a transformer to obtain, from the source data, the data object decoupled from a structure of the source data. For example, the transformer may be customized to identify a particular structure of the source data, so that decoupling the structure may be reversed by the transformer after applying the overlay. In block 930, the overlay is applied to modify the data object. For example, the overlay may update, delete, overwrite, or perform other modifications to at least a portion of the data object, according to modify attributes of the applied overlay(s). In block 940, a join operation is performed by the transformer to provide, as resulting data, the data object as modified by the overlay. The join operation may be based on re-integrating the modified data object with a structure, such as the original structure of the source data, or another structure that happens to be desired (e.g., to feed changes back to the source data for updating the source data). In block 950, the resulting data object is provided by the transformer to be interacted with as though the data object was the source data as modified by the overlay, without modifying the source data. For example, there is no need to modify the source data, because the overlay may provide the resulting data in a format that is usable to an end user consumer of the data, without realizing that the overlay has even been invoked, because the resulting data appears in the same format as the original source data would, but with the corrections overlaid as desired.

The present disclosure is not intended to be limited to the examples shown herein, but is to be accorded the widest scope consistent with the principles and novel features disclosed herein. For example, it is appreciated that the present disclosure is not limited to a particular configuration, such as computing system 400. The various illustrative modules and steps described in connection with the examples disclosed herein may be implemented as electronic hardware, computer software, or combinations of both. Examples may be implemented using software modules, hardware modules or components, or a combination of software and hardware modules or components. Thus, in an example, one or more of the example steps and/or blocks described herein may comprise hardware modules or components. In another example, one or more of the steps and/or blocks described herein may comprise software code stored on a non-transitory computer readable storage medium, which is executable by a processor.

To clearly illustrate this interchangeability of hardware and software, various illustrative components, blocks, modules, and steps have been described generally in terms of their functionality (e.g., the display processor driver 430). Whether such functionality is implemented as hardware or software depends upon the particular application and design constraints chosen for the overall system. Those skilled in the art may implement the described functionality in varying ways for each particular application, but such implementation decisions should not be interpreted as causing a departure from the scope of the present disclosure.

1. A non-transitory machine-readable storage medium encoded with instructions executable by a computing system that, when executed, cause the computing system to:
identify, based on an overlay, a data object associated with original source data; and
apply the overlay to modify the data object to be provided as resulting data to be interacted with as though it were the original source data as modified by the overlay, wherein a transformer is to provide the resulting data independent of the original source data, and wherein the resulting data is provided with a same data structure as the original source data with differences relative to the original source data as modified by the overlay.

2. The storage medium of claim 1, wherein the overlay includes a match attribute including a name and value to identify the data object based on checking the original source data for the match attribute, and includes a modify attribute including a name and value to modify the data object in response to the match attribute being satisfied.

3. The storage medium of claim 2, wherein the overlay is to identify the data object based on an exact match of the match attribute.

4. The storage medium of claim 2, wherein the overlay is to identify the data object based on a regular expression (REGEX) to match the match attribute.

5. The storage medium of claim 1, wherein the overlay includes a priority to identify an order in which to apply the overlay in relation to other overlays.

6. The storage medium of claim 1, wherein the overlay includes a source data identifier to target the original source data whose data object is to be modified.

7. The storage medium of claim 1, further comprising an overlay repository to store and retrieve the overlay to be provided to the transformer.

8. The storage medium of claim 1, further comprising instructions that cause the computing system to apply a plurality of overlays to iteratively modify the data object.

9. The storage medium of claim 1, wherein the transformer is customizable to accommodate the structure of the original source data, including an object graph associated with the structure, to obtain a geneticized model of the data object from the original source data regardless of the structure of the original source data.

10. The storage medium of claim 1, wherein the transformer is to access a portion of the original source data to perform a split operation to obtain the data object decoupled from structure, without needing to access an entirety of the original source data.

11. The storage medium of claim 1, wherein the transformer is to perform a customizable join operation to couple the data object with a desired type of structure different than the structure of the original source data.

12. The storage medium of claim 1, wherein transformer is to provide the resulting data as changes made relative to the original source data.

13. The storage medium of claim 1, further comprising instructions that cause the computing system to identify potential issues with applying the overlay based on a validation framework, and disable a problematic overlay.

14. A non-transitory machine-readable storage medium encoded with instructions executable by a computing system that, when executed, cause the computing system to:
identify, based on an overlay, a data object associated with original source data;
perform, by a transformer, a split operation to obtain, from forwarded source data, the data object decoupled from a structure of the original source data;
apply the overlay to modify the data object; and
perform, by the transformer, a join operation to provide, as resulting data, the data object as modified by the overlay;
wherein the transformer is to provide the resulting data object to be interacted with as though the data object was the forwarded source data as modified by the overlay, without modifying the forwarded source data, and wherein the resulting data is provided with a same data structure as the original source data with differences relative to the original source data as modified by the overlay.

15. A method, comprising:
identifying, based on an overlay, a data object associated with forwarded source data;
applying the overlay to modify the data object to be provided as resulting data; and
providing, by the transformer, the resulting data object to be interacted with as though it were the forwarded source data as modified by the overlay, without modifying the forwarded source data, and wherein the resulting data is provided with a same data structure as original source data with differences relative to the original source data as modified by the overlay.
